(19) United States
(12) Patent Application Publication
(10) Pub. No.: US 2003/0101269 A1
(43) Pub. Date: May 29, 2003

(54) Device interface agent

(75) Inventor: King F. Choi, Lexington, MA (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/994,313

(22) Filed: Nov. 26, 2001

(51) Int. Cl. G06F 15/16

(52) U.S. Cl. 709/228; 709/203

(57) ABSTRACT

The present invention is a system that allows for communication between a remote server computer and an external local device attached to a client computer. The server computer places instructions in a cookie file stored on the client computer. A Device Interface Agent program (DIA) on the client computer that reads the cookie access file. The DIA program communicates with the external device, in accordance with the server's or applet's instructions. Through this system, the cookie file or limited access file may be used to facilitate control of the external device, by the server computer.

### BACKGROUND OF THE INVENTION

1. Field of the Invention

The present invention is directed to controlling an external device through a limited access file and, more particularly, the present invention relates to a system for controlling an external hardware device through a browser using a cookie file containing a command.

2. Description of the Related Art

Typical computer applications that require interface with an external device achieve the necessary interface by issuing input/output requests through an I/O port using a serial interface such as an RS-232 serial port, USB, or FireWire. Examples of such external devices include, but are not limited to, disk drives, measurement devices, digital cameras, printers, tape drives, CD-ROM drives, and various media devices.

The proliferation of the Internet, and networks such as corporate intranets and virtual private networks, has increased the need for the ability of remote computers to communicate with one another and various computer operated devices. Communication between computers at different locations has become an essential part of modern business. Hyper Text Markup Language (“HTML”) is the document format used to display documents on the World Wide Web. HTML facilitates the transfer of documents via Internet, but does not assist in the transfer of programs.

Programming languages such as Java allow for the creation of small programs that may be attached to web pages and move from computer to computer via the Internet. These Internet applications, or “applets”, are able to run on any number of computer platforms without the need to install software or modify the operating system settings of the computer running the applet. When a computer user requests a web-page containing a Java applet, the server automatically transfers the applet to the requesting user's browser. Such an applet typically provides an interface that allows the user to enter some inputs, hit a button, and get the desired outputs. Furthermore, such input or output data can often be sent back to the remote computer for more processing. This process greatly enhances the ability of computers to remotely transfer programs via the Internet.

There is however, currently a significant limitation on the functionality of browsers and programs such as applets, which are run through the browser interface. For security reasons, Internet or web-based applications are not permitted to issue direct input/output commands to a remote computer. This limitation includes the input/output commands required to communicate with all devices attached to the local computer. This limited functionality or access capability presents a problem for servers that wish to send input/output instructions to another computer or an attached external device, through an internet application. Applets are only permitted to output small amounts of data in a Persistent Client State HTTP Cookie file, or other similar limited access file. These small amounts of data are commonly referred to as “cookies” and are stored in the client computer for the purpose of facilitating client-server communication.

The limited functionality of browsers may be overcome by the employment of a browser plug-in or ActiveX component; however, there are a number of problems associated with this approach. Plug-ins are small software programs that plug into a larger application for the purpose of increasing the application's functionality. Similarly, ActiveX components are also used to add functionality to an application or web-page.

One problem associated with using either Plug-ins or ActiveX involves the tedious nature of the interface. Although a plug-in or ActiveX control may be created through any number of languages, the process is significantly more challenging than the present invention. For example, in the generation of a Netscape browser plug-in, a user has to write some native programs (typically in C/C++) to interact with the client computer file-structure or external devices. He/She also needs to write some Java code as a wrapper to allow the Java applet to indirectly interact with the native programs. All the native programs and Java wrapper have to be properly installed in the right place for the plug-in to work.

Plug-ins are also browser specific. As a result, the same interface would need to be programmed multiple times for different browsers, different operating systems, and sometimes, different browser versions.

Furthermore, the use of a plug-in can alter the system resources of the client computer. Computer users often become aware of the web-based programs altering the system resources of their computer by the inevitable slowing down of other applications and overall performance. Other essential computer functions may also be severely hampered by the functioning of the plug-in.

Additionally, because plug-ins are auxiliary software programs, they must be downloaded from a remote computer and installed on the local computer's disk drive. This presents an additional security problem due to the potential risk of viruses. As computer users and network administrators have become increasingly wary of downloading executable files from the Internet, programs such as plug-ins have become disfavored.

Therefore, a need exists for a system that will allow a server to communicate through a browser interface with a local computer and the external devices attached to it.

### SUMMARY OF THE INVENTION

It is an aspect of the present invention to provide a system that allows a remote computer to communicate with an external hardware device attached to a local computer.

It is an additional aspect of the present invention to provide for control of an external device via the Internet, or other network, without the need for a plug-in or ActiveX component.

The above aspects can be obtained by running a Device Interface Agent (“DIA”). The DIA program takes advantage of the fact that limited access applications, such as browsers, are permitted to output small amounts of data in a cookies file or other similar limited access file. The cookies are stored in the client computer to facilitate client-server communication. Input/output commands, to an external device, can be facilitated by launching the DIA program to examine the cookies file at regular intervals and then perform an operation. During operations the client computer browser stores the cookie, which contains a command. The stored DIA program on the client computer reviews the command in the cookie file. The stored program performs a desired operation as instructed by the command in the cookie. The stored program may then communicate the results of the operation to the client computer browser through the operating system. The client computer browser may then communicate the results to the server computer.

The present invention provides the advantageous technical effect of allowing a server to communicate through a browser with a local computer and the external devices attached to it.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts interaction between software and hardware components of the present invention.

FIG. 2 shows the flow of operations of the software components.

FIG. 3 depicts the operation of the Java applet in greater detail.

FIG. 4 depicts the operation of the DIA program in greater detail.

FIG. 5 illustrates the interaction between a browser, remote server, and cookies file.

FIG. 6 depicts a typical cookie file.

### DETAILED DESCRIPTION OF THE PREFERRED EMBODIMENTS

The present invention is directed to facilitating communication between a remote computer (server), and a local computer (client) over a network, through use of limited access applications and files. It should be emphasized that the reason for creating such a system is integral with the broadest problems in network communications and is not limited to communications between a server computer and any particular device.

A limited access file is a file to which certain computers and applications have access. A cookies file is a limited access file. A cookies file may contain many individual cookies. A cookie is a set of data that a website server gives to a browser the first time the user visits the site and which is typically updated with each return visit. The remote server saves the information the cookie contains about the user and the user's browser does the same, as a text file stored in the browser system folder. Not all browsers support cookies. Cookies store information such as user name and password and what parts of the site were visited; this information can be updated with each visit. The browser only shares each cookie with the server that originated it; other servers can only read their own cookies.

An applet is a type of limited access application. An applet is not allowed to access system resources directly. That is, a limited access application, such as an applet, cannot issue input/output commands to the computer or client on which the browser is running. A browser is also a type of limited access program.

Documents are easily transmitted over a network, or series of networks such as the Internet, through use of HTML. A direct interface between computers at different locations is not as easily achieved. The process is further complicated if a remote computer wishes to send a direct input/output command to an external device attached to a local computer. For example, a local computer may have an external device attached to it for the purpose of collecting data or performing some function. The data may be in the form of visual images, system measurements, temperature readings, or any number of facts, figures, or other measurements. Currently, web-based programs that seek to communicate with such devices must be constructed as standalone applications. Programs that function through the browser interface are not permitted the functionality needed to send input/output commands to a remote computer or attached device.

By creating an interface that works within the confines of a browser's limited functionality, web-based programs will be able to communicate with client computers and any attached devices. The present invention provides such an interface.

As noted above, web-based applications are not allowed to send direct commands to a client computer and are only permitted to use the client computer browser to output small amounts of data in a cookies file, or other similar limited access file. The present invention uses these limited access files to facilitate communication between web-based or limited access applications and a client computer.

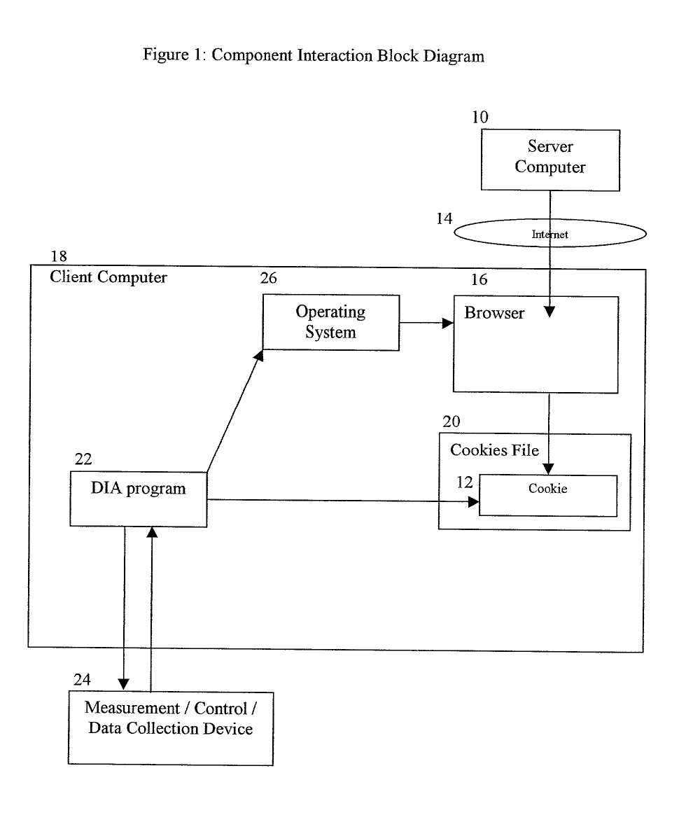

The present invention can be implemented in a system, such as shown in FIG. 1, which depicts a simplified version of the interaction between the components of the invention. Server computer 10 sends a cookie 12, containing a command, over the internet 14 to the browser 16. The browser 16 is a stored program on the client computer 18. The browser 16, through an applet or other browser application, stores the cookie 12 in a designated cookies file 20. Depending upon the brand of the browser 16, the cookie 12 may alternatively be stored by itself as its own individual cookies file 20; in which case each cookie 12 would correspond with a unique cookies file 20. The DIA program 22 determines that a new cookie 12 is present and examines the cookie 12 for a command. The DIA program 22 then relays the command to an attached device 24 that performs an operation in accordance with the command.

Additional implementations of the present invention may have the attached device 24 send the results of the operation to the DIA program 22. The DIA program 22 then sends the results to the operating system 26. The operating system 26 sends the results to the browser 16. The browser 16 then sends the results over the Internet 14 to the server computer 10.

One example of an application of the present invention would be using the invention to move a camera to a desired position. The server computer 10 sends a cookie 12, containing the move-camera-to-desired-position command, over the internet 14 to the browser 16. The browser 16, through an applet or other browser application, stores the cookie 12 in the designated cookies file 20 or as an individual file. The DIA program 22 determines that a new cookie is present and examines the cookie 12 for the command. The DIA program 22 relays the move camera command to the attached camera 24, which in turn moves to a position in accordance with the command. In this situation there is no need for the attached camera 24 to send information back to the server computer 10, via the DIA program 22, operating system 26, browser 16, and internet 14.

The browser 16 is capable of running small web-based programs that are typically written in Java and referred to as applets. When the browser 16 makes a request via the Internet 14 for an HTML page from the server computer 10, the server computer 10 may include an applet with the HTML transmission. The applet is able to perform tasks through the browser 16 interface, including writing the cookie 12 to the cookies file 20. Of course, other browser based applications may also be used to perform this function and an applet is not required for the browser 16 to store a cookie 12.

Another example of an application of the present invention would be making a client computer 18 system measurement, or collecting data through use of the external device 24. When a client computer user decides to begin the measurement or data collection process he or she launches the browser 16 and the browser 16 makes an HTML request to the server computer 10. The server computer 10 includes an applet with the HTML document sent to the client computer 18. The applet displays a start measurement button on the client computer display/monitor that the user selects when ready to begin the process. When the user clicks the start measurement button the applet operates through the browser 16 interface and writes a cookie 12 with a make measurement command to the cookies file 20. This particular cookie 12 will be referred to as the “make measurement cookie.”

The DIA program 22 may be run periodically by the client computer user or run continuously as a background process. The DIA program 22 examines the cookies file 20 at regular intervals looking for the make measurement cookie 12. When the DIA program 22 detects the make measurement cookie 12 it sends an instruction to the measurement/data collection device 24 to make a measurement.

Upon completion of the measurement, the measurement/data collection device 24 may be configured to send the data to the server computer 10. In this situation the measurement/data collection device 24 sends to data to the DIA program 22. The DIA program 22 sends the data through the operating system 26 back to the applet. The applet, operating through the browser 16 interface, receives and stores the data from the operating system 26 and may begin the measurement process again if additional data collection is required. When the measurement and data collection is complete, the applet sends the data back to the server 10 via the Internet 14.

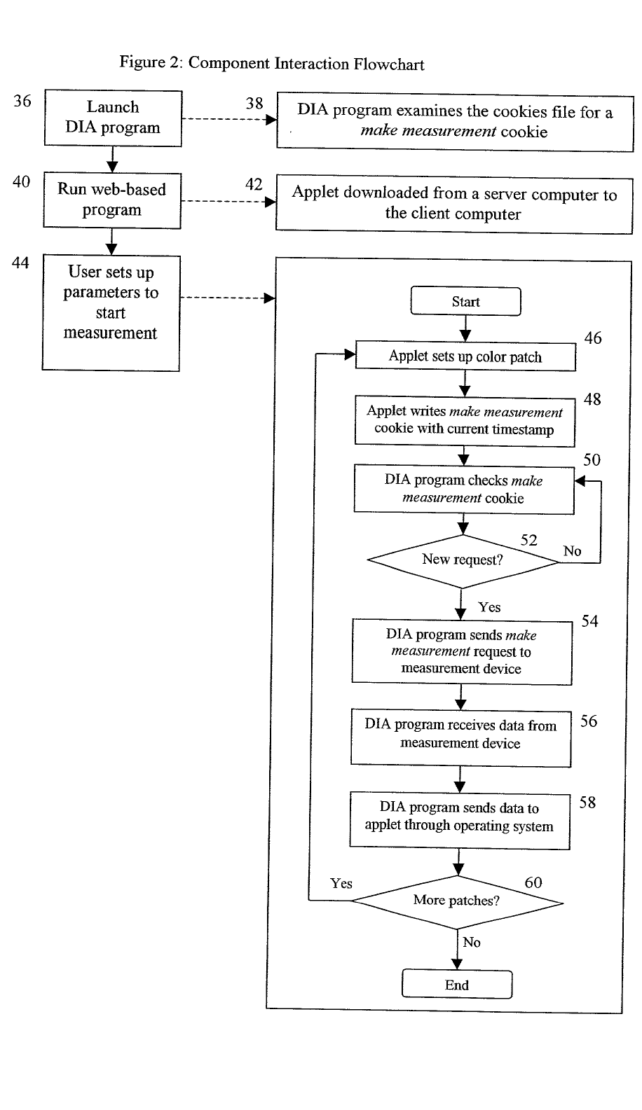

The FIG. 2 flowchart further describes the component interaction for a conventional system of measuring the precision of the client computer 18 monitor or display device. Once the DIA program 22 is launched 36, it examines 38 the cookies file 20 at regular intervals to look for the make measurement cookie 12. The client computer user then directs the browser 16 to an appropriate web page, to initiate 40 a web-based program. At this point the server transmits 42 an applet to the client computer 18 with the HTML page. The client computer user then sets-up 44 parameters to start the measurement and data collection. The applet sets 46 a color patch on the monitor to facilitate the measurement device's data collection. The applet also writes 48 the make measurement cookie 12 containing a current timestamp, to the cookies file 20.

Because the DIA program 22 is active, it regularly checks 50 the cookies file 20 for the make measurement cookie 12. If the DIA program 22 detects the make measurement cookie 12, it examines and record the cookie's timestamp for later comparison. By continually comparing the recorded timestamp with the make measurement cookie's timestamp the DIA program 22 is able to determine 52 whether the applet (or server) has sent a new make measurement command. Once the DIA program 22 determines that the applet has sent a new command, it sends 54 a make measurement request to the measurement device 24. When the measurement device 24 has completed collecting the data, it relays 56 the data to the DIA program 22. The DIA program 22 then invokes a system call to send 58 the data through the operating system 26 to the applet. After receiving the data from the operating system 26, the applet determines 60 whether additional color patches should be set or displayed and additional measurements taken. In some applications, the user may be satisfied with just examining the data collected. In other applications, the user may decide to send the data to the server computer for more processing. In yet other applications, the applet may send the data to the server without any user intervention.

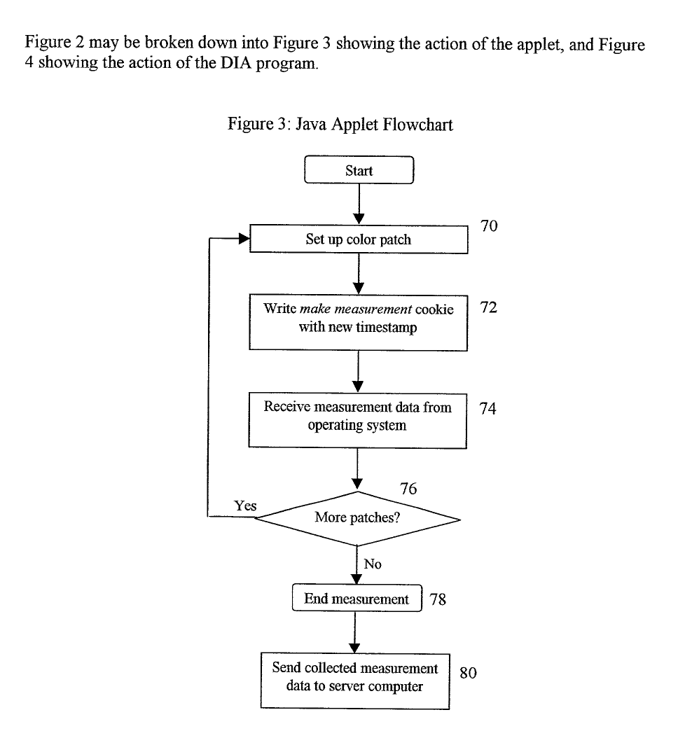

FIG. 3 depicts the functioning of an applet for a conventional system of measuring the precision of a computer monitor in more detail. Once the browser 16 has received the applet from the server, the applet begins functioning by setting or displaying 70 a color patch on the monitor to facilitate the measurement(s). The applet then writes 72 make measurement cookie 12 with a new timestamp to the cookies file 20. Once the measurement has been made, the applet receives 74 the measurement data from the operating system 26 of the client computer 18. The applet then determines 76 whether additional measurements are required. If more measurements are required, the process begins again by the applet setting 70 a color patch or series of color patches. Once the measurement process has been completed 78, the user may be satisfied with just examining the data collected, or he/she may send the data to the server computer. In the latter case, the applet sends 80 the collected measurement data to the server 10.

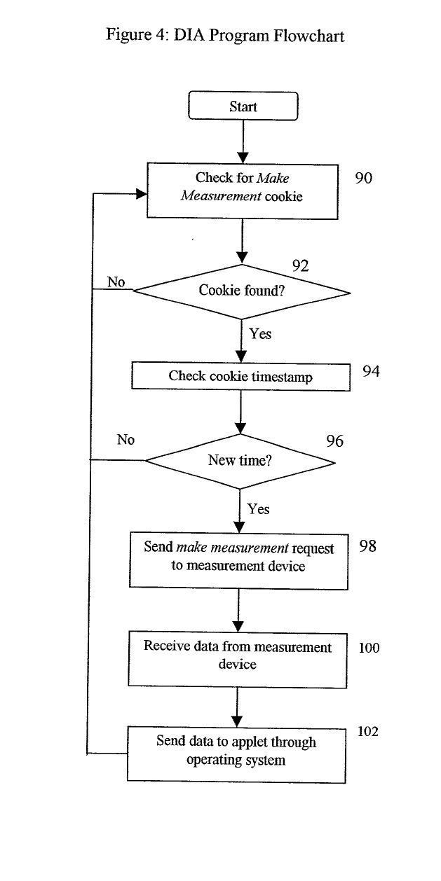

FIG. 4 describes in greater detail the functioning of the DIA program 22. Once the client computer user launches the DIA program 22, the program begins by checking 90 the cookies file 20 for the make measurement cookie 12. When the make measurement cookie 12 is found 92, the DIA program 22 checks 94 the cookie's timestamp. The DIA program 22 determines 96 whether the cookies file 20 contains a new make measurement cookie 12, or if the previously viewed cookie 12 contains a new timestamp. If a new make measurement cookie 12 is present, or the previously viewed make measurement cookie 12 contains a new time stamp, the DIA program 22 sends 98 a make measurement request to the measurement device 24. In this case, the measurement device 24 is a device for measuring the color of a display, such as a colorimeter. After the measurement has been taken, the DIA program 22 receives 100 the data from the measurement device 24. The DIA program 22 then sends 102 the data through the operating system 26 to the applet. At this point the DIA program 22 continues to check 90 for the make measurement cookie 12.

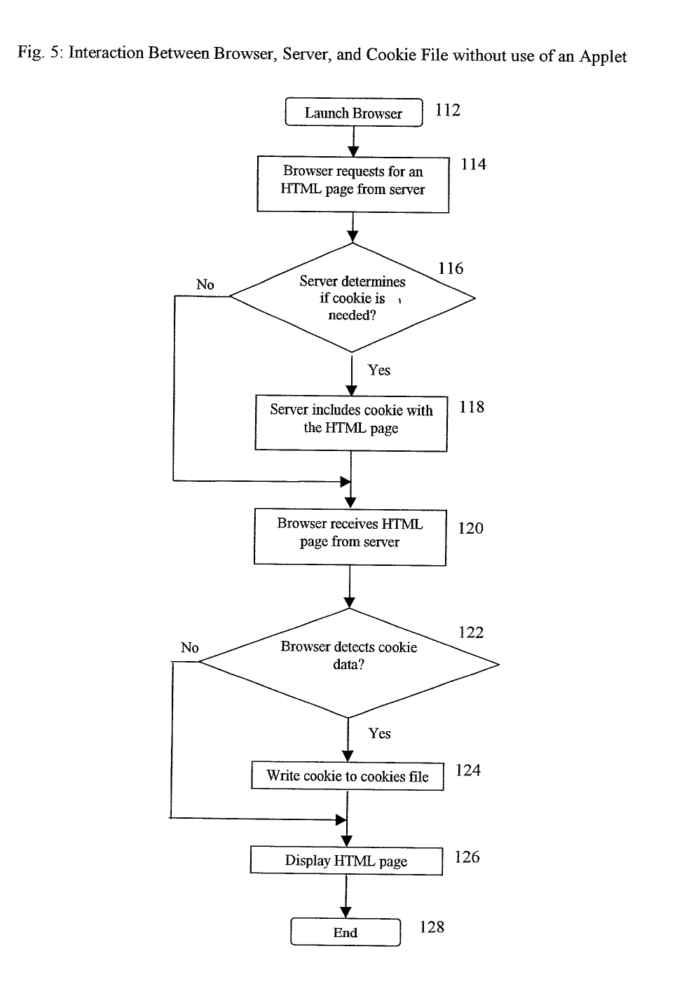

FIG. 5 shows a typical interaction between a browser 16, a server 10, and a cookies file 20, without the use of an applet. The client computer user begins by launching 112 the browser 16. The user directs the browser 16 to a desired web page on the server 10, at which time the browser 16 requests 114 an HTML page from the server 10. If the user has previously visited the web site, the browser 16 includes with the HTML request data from a cookie 12 that was stored on the client computer 18 during the previous visit to the website. If the browser 16 has not previously visited the web site, the server 10 determines 116 that the client computer 18 needs a cookie 12. The server 10 includes 118 a cookie 12 with the HTML page sent to the browser 16.

When the browser 16 receives 120 the HTML page from the server 10, the browser 16 ascertains 122 whether cookie data has been sent with the HTML document. If cookie data has been sent, the browser 16 writes 124 the cookie 12 to the cookies file 20. The browser 16 then displays 126 the HTML page that was sent by the server 10 Once the cookie is updated, the DLA program initiates performance of the command of the cookie.

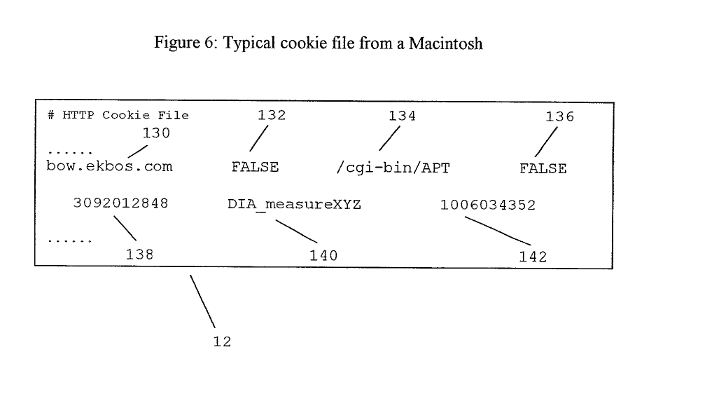

FIG. 6 illustrates the content of a cookie 12 in a typical Netscape® browser 16 generated cookies file 20. In an actual cookies file 20 the various fields would appear on the same line and additional cookies would appear above and below the ellipses shown in the figure. The first field 130 is the uniform resource locator (URL) of the server computer 10 that provided the data for the cookie 12. The next field 132 is unused. The third field 134 provides information about the path or directory on the server computer 10 associated with this cookie 12. The fourth field 136 is unused. Field 138 contains the expiration time of the cookie 12 for use by the browser 16. The browser 16 uses the expiration date to determine the age of the cookie 12 and whether it should continue to store the cookie 12. The next field 140 is the name or identifier of the cookie. The name used as an example in FIG. 6 is DIA_measureXYZ which is the command for the DIA program 22. The final field 142 is the value (content) of the cookie 12. In the present invention, the value of the cookie 12 is preferably be the timestamp set by the applet. As previously discussed, the DIA program 22 preferably continually checks field seven 142 to determine whether a new timestamp has been written.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### Reference Number List

10 Server Computer

12 Cookie

14 Internet

16 Browser

18 Client computer

20 Cookies file

22 DIA program

24 Measurement device

26 Operating system

36-128 Computer operations

130-142 Cookie fields

What is claimed is:

1. An apparatus, comprising:
a server transmitting a cookie;
a client receiving the cookie and issuing a device command responsive to the cookie; and
a device performing an operation responsive to the command.

2. An apparatus as recited in claim 1, wherein a result of the operation by the device is communicated to the server by the client.

3. An apparatus as recited in claim 2, wherein the client comprises:
an operating system;
a browser storing the cookie in a cookies file and communicating result data to the server; and
a device interface agent application accessing the cookie, controlling the device responsive to command data of the cookie and providing the result data to the browser through the operating system.

4. An apparatus as recited in claim 3, wherein the device makes a measurement external to the client.

5. An apparatus as recited in claim 3, wherein the device makes a measurement of the client computer.

6. An apparatus, comprising:
a packet switched communication network a server transmitting a cookie over the network;
a controlled device performing an operation responsive to a device command and producing a result of the operation; and
a client coupled to the controlled device, receiving the cookie and issuing the device command to the controlled device responsive to the cookie and communicating to the server over the network, the client comprising:
an operating system;
a cookie storage;
a browser storing the cookie in the cookie storage and communicating result data to the server; and
a device interface agent application accessing the cookie, controlling the controlled device responsive to command data of the cookie and providing the result data to the browser through the operating system; and
the controlled device performing an operation responsive to the cookie where a result of the operation by the controlled device is communicated to the server by the client.

7. An apparatus, comprising:
a packet switched communication network
an applet downloaded from a server over the network capable of sending a cookie,
a controlled device performing an operation responsive to a device command and producing a result of the operation;
a client coupled to the controlled device, receiving the cookie and issuing the device command to the controlled device responsive to the cookie and communicating to the server over the network, the client comprising:
an operating system;
a cookie storage;
a browser storing the cookie in the cookie storage, initiating execution of the applet and communicating result data to the server; and
a display device displaying color patches as instructed by the applet; and
a device interface agent application accessing the cookie, controlling the controlled device responsive to command data of the cookie and providing the result data to the browser through the operating system; and
the controlled device performing a color measurement responsive to the cookie where the color measurement by the controlled device is communicated to the server by the client.

8. A method, comprising:
loading a limited access file from a remote location with data; and
performing an operation responsive to the data contents of the limited access file.

9. A method as recited in claim 8, wherein the limited access file comprises a cookies file and the data comprises a cookie having a command therein and the operation is performed responsive to the command.

10. A method, comprising:
executing a limited access application to store data; and
performing an operation responsive to the data.

11. A method as recited in claim 10, wherein the limited access application comprises an applet.

12. A method of controlling an external device comprising sending a cookie from a server to a client and initiating control of the device via the client through the cookie.

13. A method of facilitating communication between a client computer and server computer, comprising:
writing a limited access file to the client computer with data from the server computer;
running a background program on the client computer to read the limited access file and communicate with other computer programs; and
operating an external device in accordance with a command from the server contained in the limited access file.

14. A method as recited in claim 13, further comprising operating an external device to gather data.

15. A method as recited in claim 14, further comprising:
operating the external device to send data gathered to the background program; and
using the background computer program to send the data gathered through the operating system to the browser; and
sending the data to another computer via the browser.

16. A method as recited in claim 13, further comprising operating the external device to send data previously gathered to another computer.

17. A method as recited in claim 13, further comprising an applet that writes to limited access files.

18. A method as recited in claim 17, further comprising operating the external device to gather data.

19. A method as recited in claim 18, further comprising:
operating the external device to send the data gathered to the background program; and
using the background computer program to send the data gathered through the operating system to the applet.

20. A method as recited in claim 19, wherein the applet sends the data received to another computer.

21. A computer readable storage controlling a computer via loading a limited access cookie file from a remote location with a cookie containing a command, and performing an operation commanded by the command.

22. A computer readable data structure controlling a computer via a cookies file containing a cookie containing a computer command.
